(19) United States
(12) Patent Application Publication
(10) Pub. No.: US 2026/0320951 A1
(43) Pub. Date: Oct. 15, 2026

(54) MODIFYING A MESH FOR A PHYSICAL ENVIRONMENT

(71) Applicant: Apple Inc., Cupertino, CA (US)

(72) Inventors: Leo Lin, Redwood City, CA (US); Amrutha Hakkare Arunachala, Sunnyvale, CA (US); Benjamin S. Phipps, San Francisco, CA (US); Charles B. Zapata, Redmond, WA (US); Jessica Bovy, Oakland, CA (US); Magnus H. Johnson, San Francisco, CA (US); Ravikiran Vadlapudi, San Jose, CA (US); Sanjana Wadhwa, San Francisco, CA (US); Shih-Yu Sun, San Jose, CA (US)

(21) Appl. No.: 19/641,809

(22) Filed: Apr. 8, 2026

Related U.S. Application Data
(60) Provisional application No. 63/785,980, filed on Apr. 9, 2025.

(51) Int. Cl. G06T 19/20

(52) U.S. Cl. CPC G06T 19/20

(57) ABSTRACT

A device obtains a mesh for a physical environment. The mesh includes various mesh elements that correspond to respective physical points in the physical environment. The device determines whether the mesh is aligned with the physical environment based on a comparison between the mesh elements and the respective physical points in the physical environment. In response to determining that the mesh is misaligned with the physical environment, the device modifies a portion of the mesh in order to generate a modified mesh that is aligned with the physical environment.

### CROSS-REFERENCE TO RELATED APPLICATIONS

This application claims priority to U.S. Provisional Patent App. No. 63/785,980, filed on Apr. 9, 2025, which is hereby incorporated by reference in its entirety.

### TECHNICAL FIELD

The present disclosure generally relates to modifying a mesh for a physical environment.

### BACKGROUND

Devices include various sensors for capturing sensor data. Some devices include cameras for capturing image data, depth cameras for capturing depth data and microphones for capturing audio data. Some devices use captured sensor data to generate a mesh for a physical environment. The mesh can be used to locate a physical item in the physical environment or to provide navigational guidance.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1J are diagrams of an example environment in accordance with some implementations.

FIG. 2 is a block diagram of a system that aligns a mesh with a physical environment in accordance with some implementations.

FIG. 3 is a flowchart representation of a method of aligning a mesh with a physical environment in accordance with some implementations.

FIG. 4 is a block diagram of a device that aligns a mesh with a physical environment in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for modifying a mesh for a physical environment. In some implementations, a device includes a display, one or more processors and a non-transitory memory. In various implementations, a method includes obtaining a mesh for a physical environment. In some implementations, the mesh includes a plurality of mesh elements that correspond to respective physical points in the physical environment. In some implementations, the method includes determining whether the mesh is aligned with the physical environment based on a comparison between the plurality of mesh elements and the respective physical points in the physical environment. In some implementations, the method includes, in response to determining that the mesh is misaligned with the physical environment, modifying a portion of the mesh in order to generate a modified mesh that is aligned with the physical environment.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

When a mesh of a physical environment is generated, certain features of the mesh may not align with corresponding features of the physical environment. For example, a corner in the mesh may not align with a corresponding corner in a room. A mesh that does not accurately represent the physical environment may have limited utility. For example, using an inaccurate mesh for navigational operations may result in erroneous or incorrect navigational guidance.

The present disclosure provides methods, systems, and/or devices for modifying a mesh for a physical environment in order to align the mesh with the physical environment. A device generates a mesh for a physical environment. The device determines whether the mesh is aligned with the physical environment by comparing features of the mesh with corresponding features of the physical environment. For example, the device identifies a corner in the physical environment and determines whether the corner in the physical environment is collocated with a portion of the mesh that represents the corner. The device modifies the mesh in order to align the mesh with the physical environment.

The device can align the mesh with the physical environment by scaling a portion of the mesh. For example, the device can stretch or compress a portion of the mesh to improve the alignment between the mesh and the physical environment. As an example, if the mesh for a room is too small to align with corners of the room, the device can stretch the mesh so that corners in the mesh align with the corners of the room.

The device can align the mesh with the physical environment by moving a portion of the mesh so that the portion of the mesh aligns with a corresponding physical feature of the physical environment. For example, the device can move a cubic element in the mesh that represents a kitchen island so that the cubic element is collocated with the kitchen island that the cubic element represents.

The device can align the mesh with the physical environment by rotating a portion of the mesh so that the portion of the mesh aligns with a corresponding physical feature of the physical environment. For example, the device can rotate a rectangular element in the mesh that represents a wall-mounted TV so that the rectangular element has the same orientation as the wall-mounted TV that the rectangular element represents.

The device can use the misalignment between the mesh and the physical environment to calibrate sensors. Some misalignment between the mesh and the physical environment may be due to sensor noise, sensor miscalibration and/or drift of sensor parameters from calibrated parameters. Calibrating the sensors can reduce sensor noise in subsequently captured sensor data and meshes generated based on the subsequently-captured sensor data may be better aligned with the physical environments that the meshes represent.

The device can use a variety of techniques to generate the mesh. For example, the device can use sensor data from a camera, a depth camera and/or a LIDAR to generate the mesh. As another example, the device can use stereoscopic feature matching to generate the mesh. As yet another example, the device can generate the mesh based on user inputs.

The device identifies fixed physical points within the physical environment and compares the fixed physical points with corresponding mesh elements to assess alignment of the mesh with the physical environment. The fixed physical points include fixed objects or relatively immovable objects such as a walls, large appliances (e.g., refrigerators), furniture (e.g., couch, TV, etc.) and architectural design elements (e.g., arches, kitchen island, kitchen cabinets, etc.).

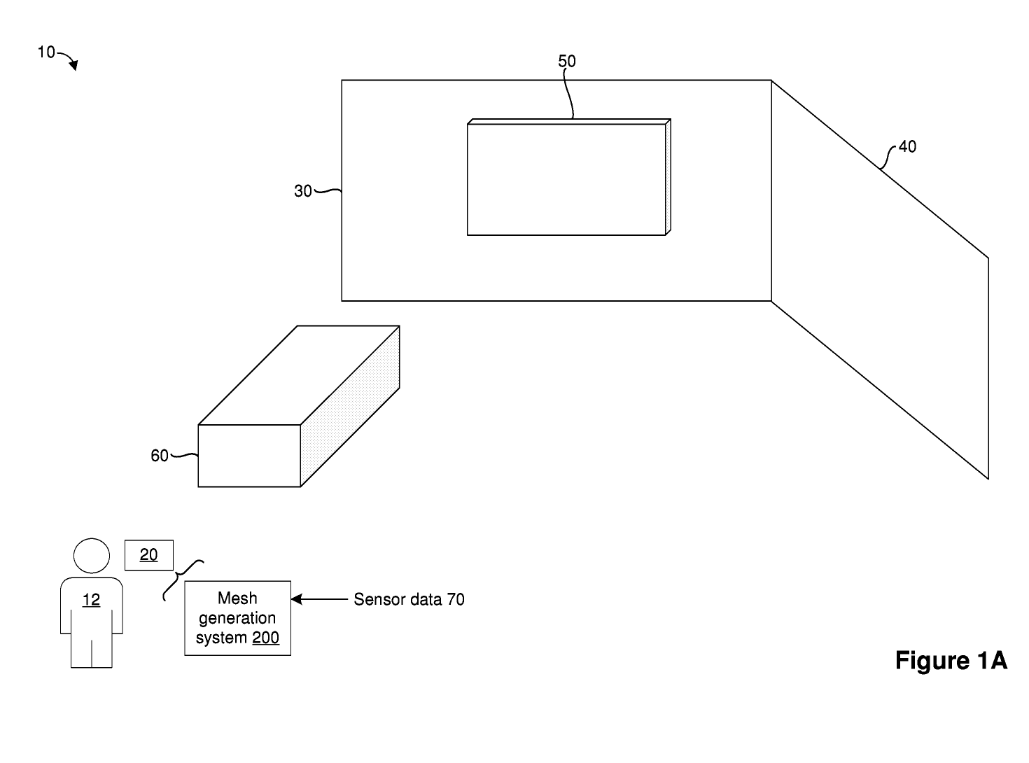

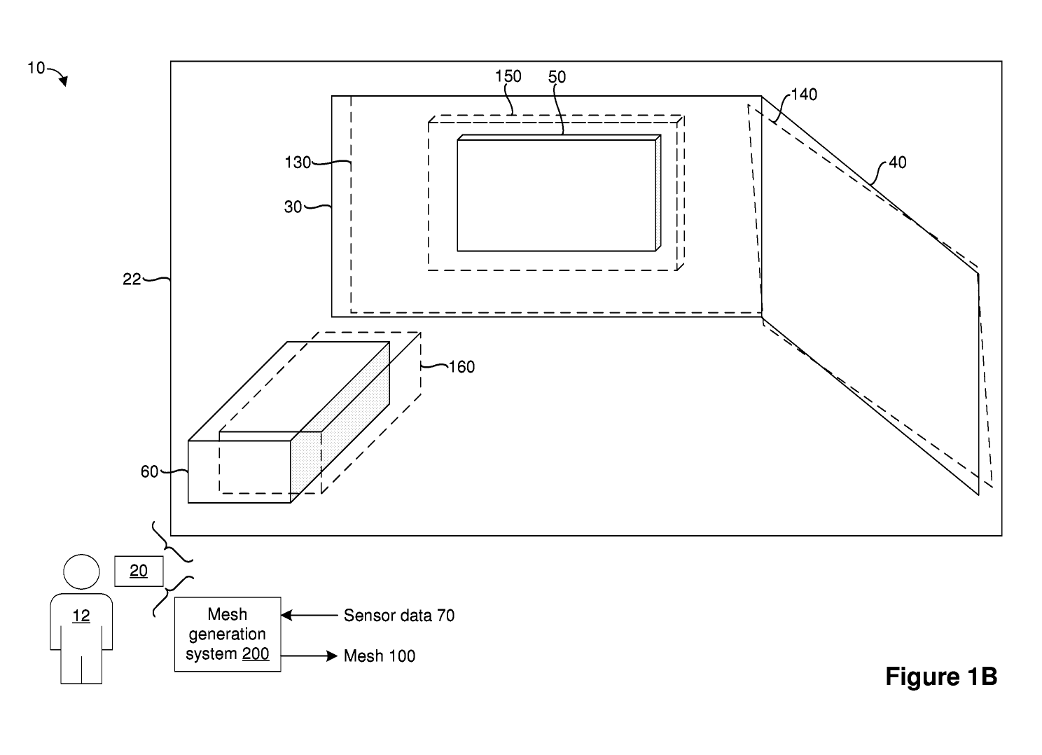

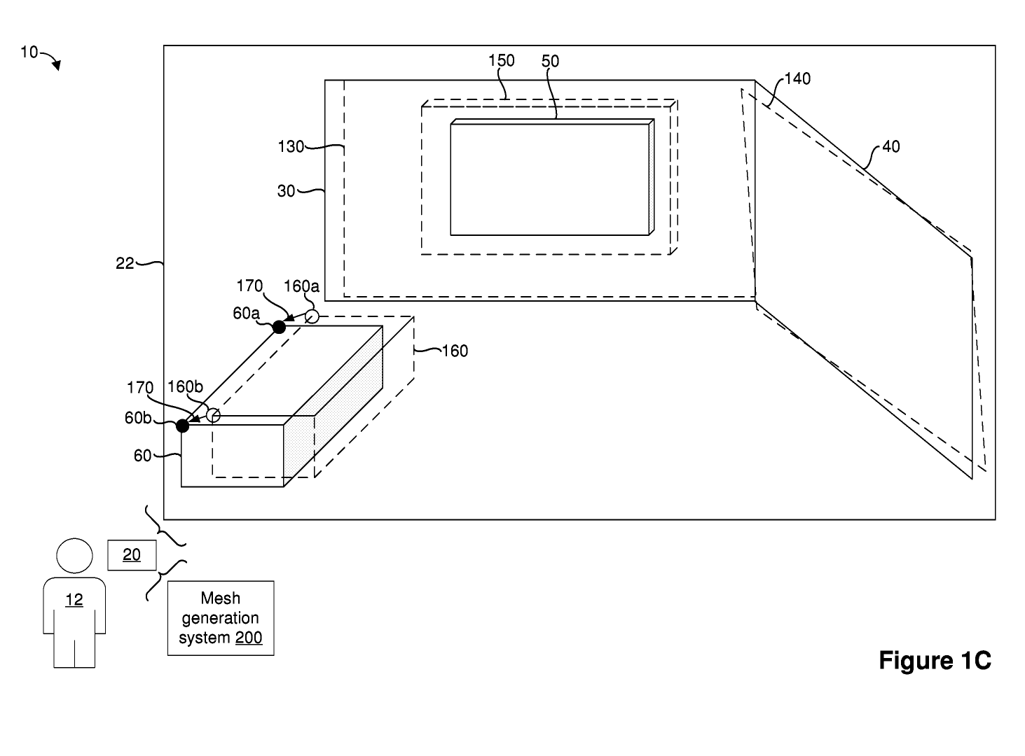

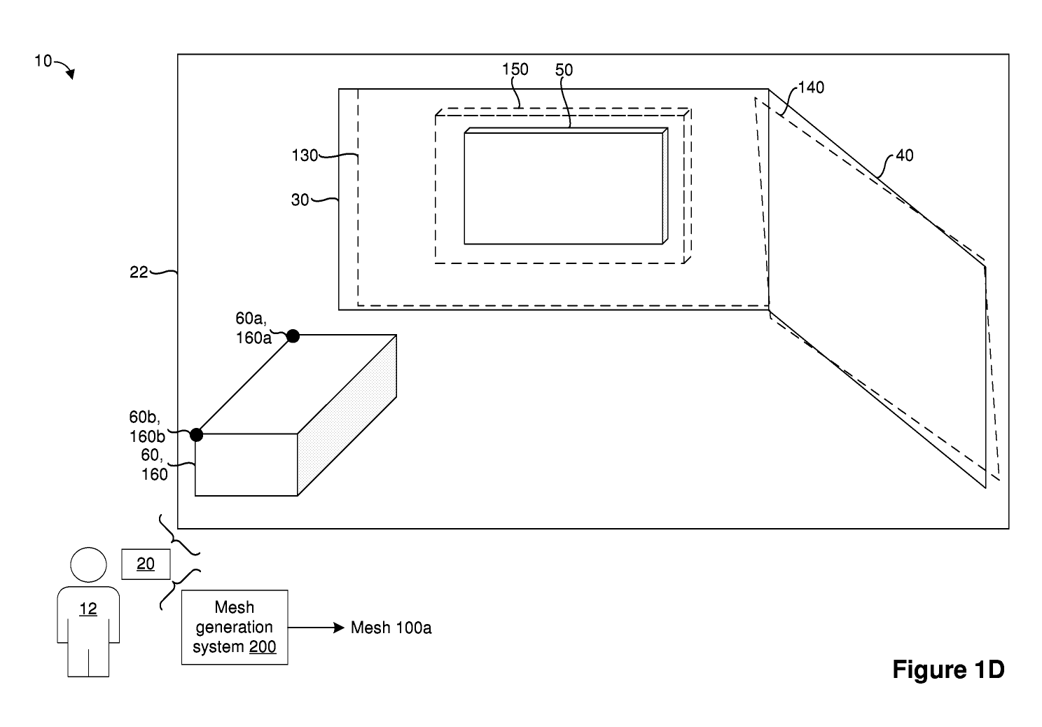

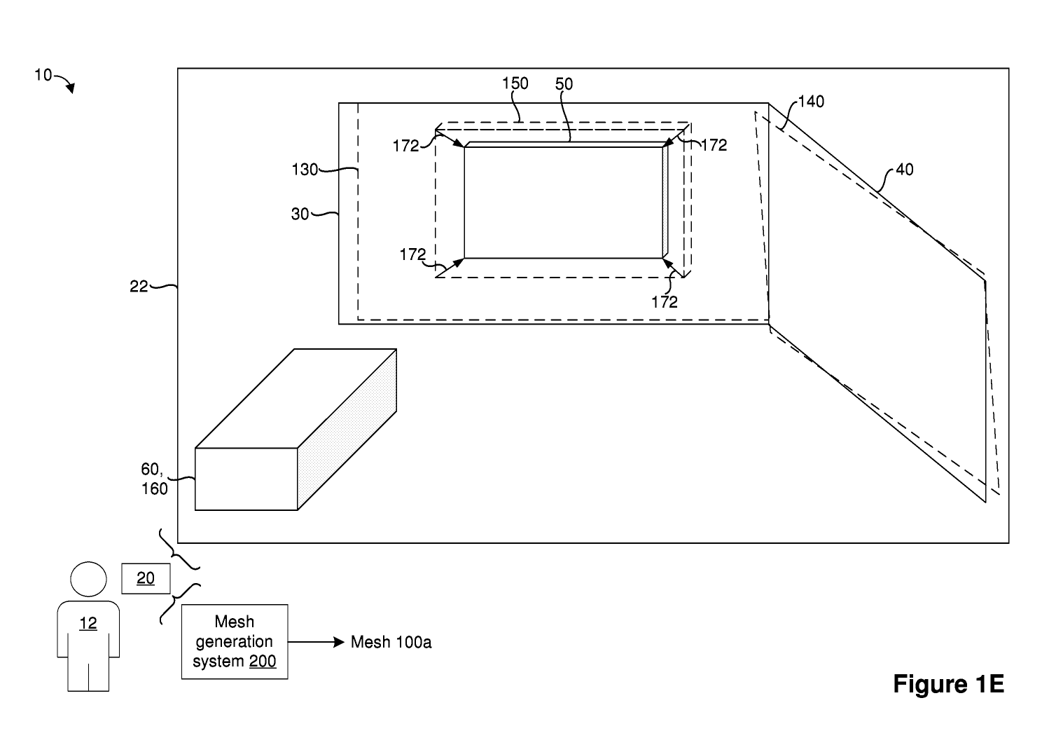

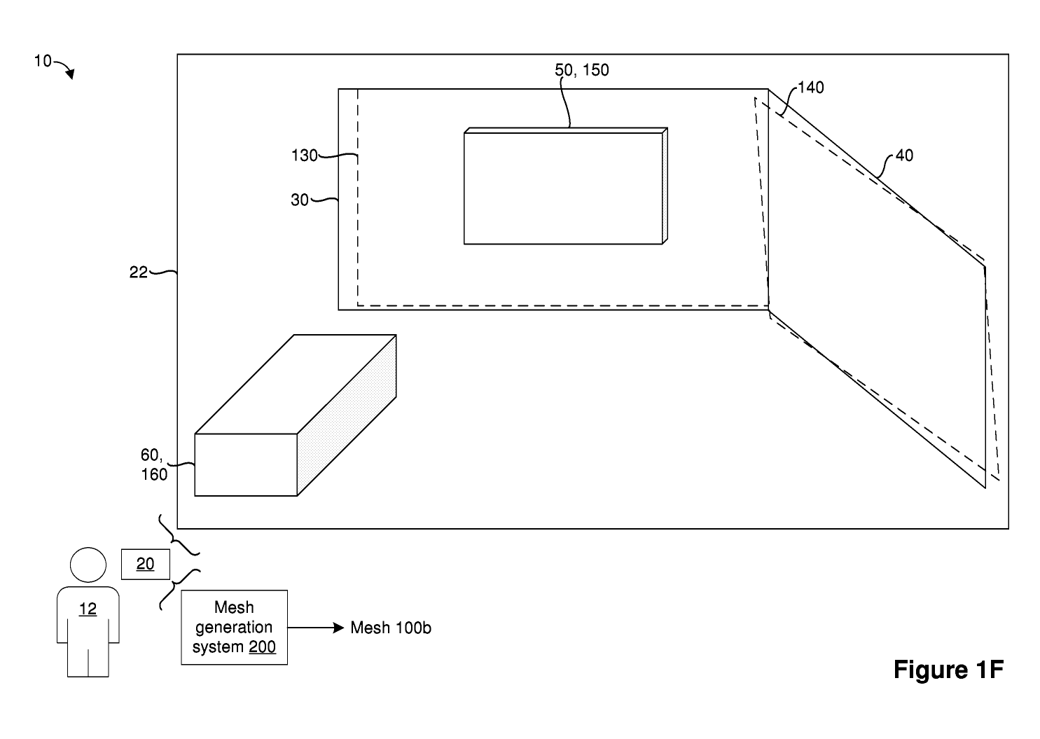

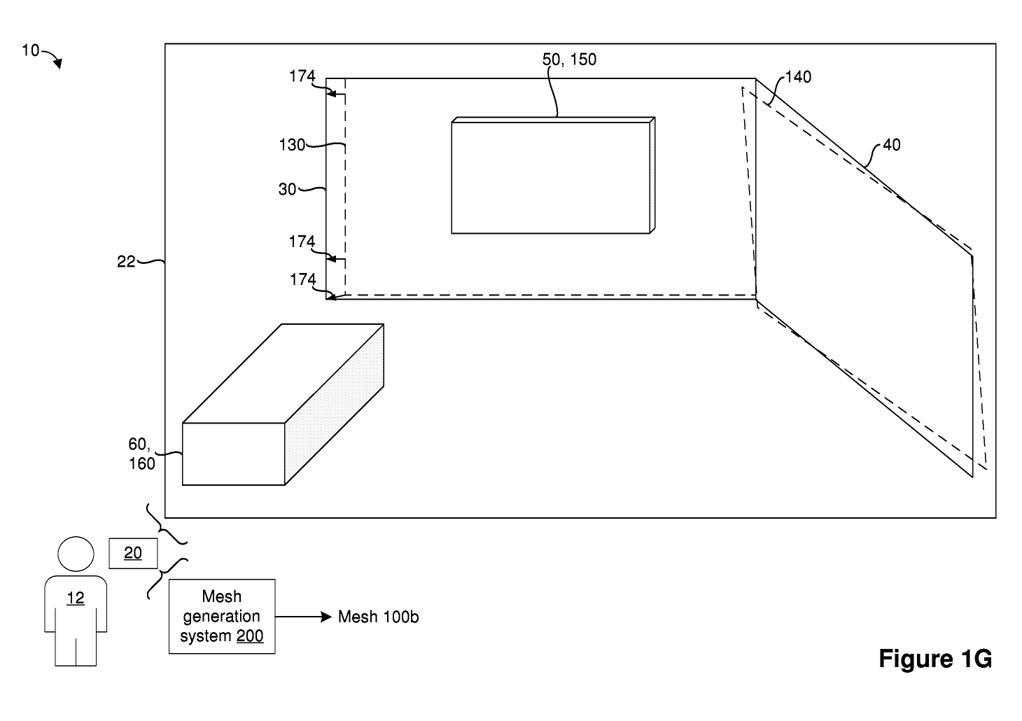

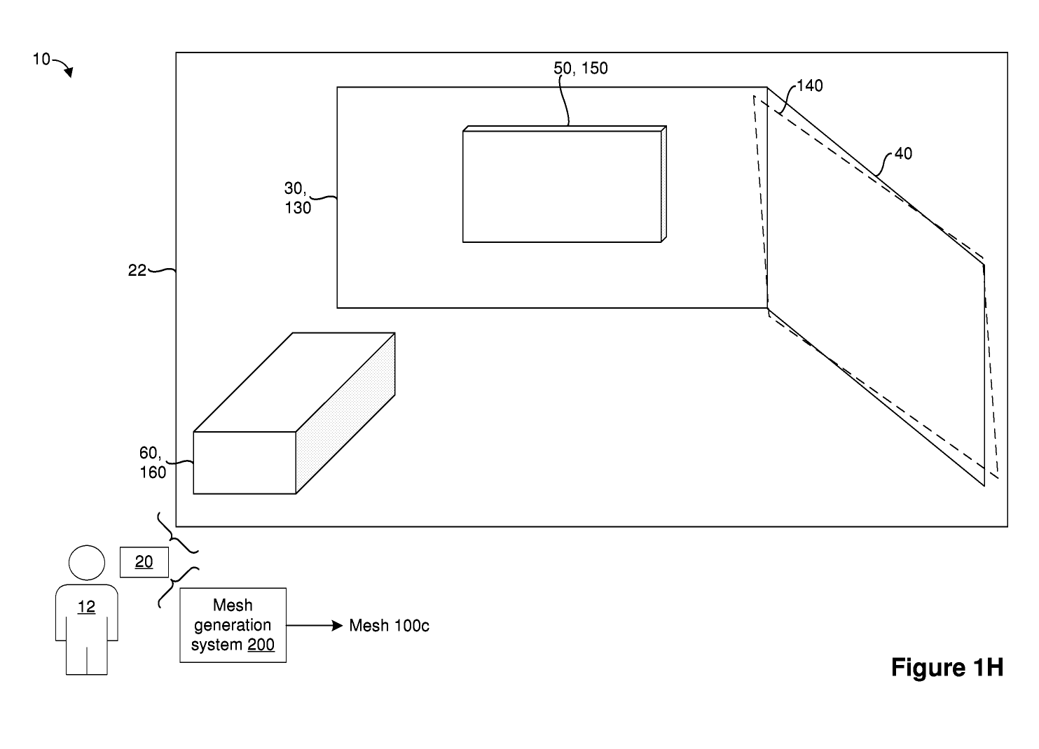

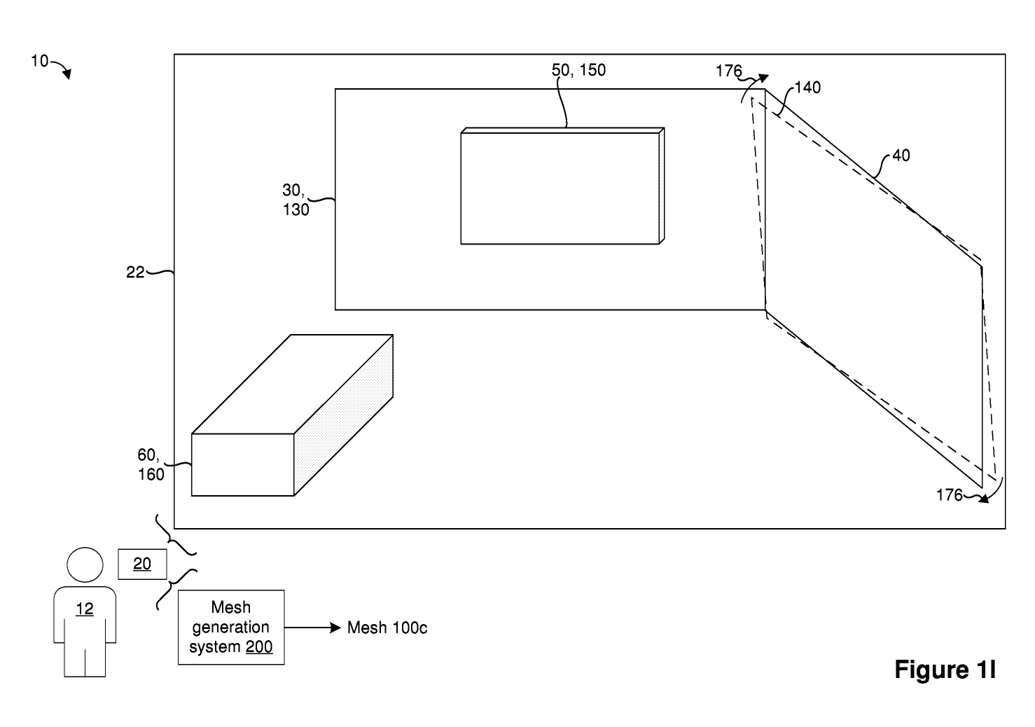

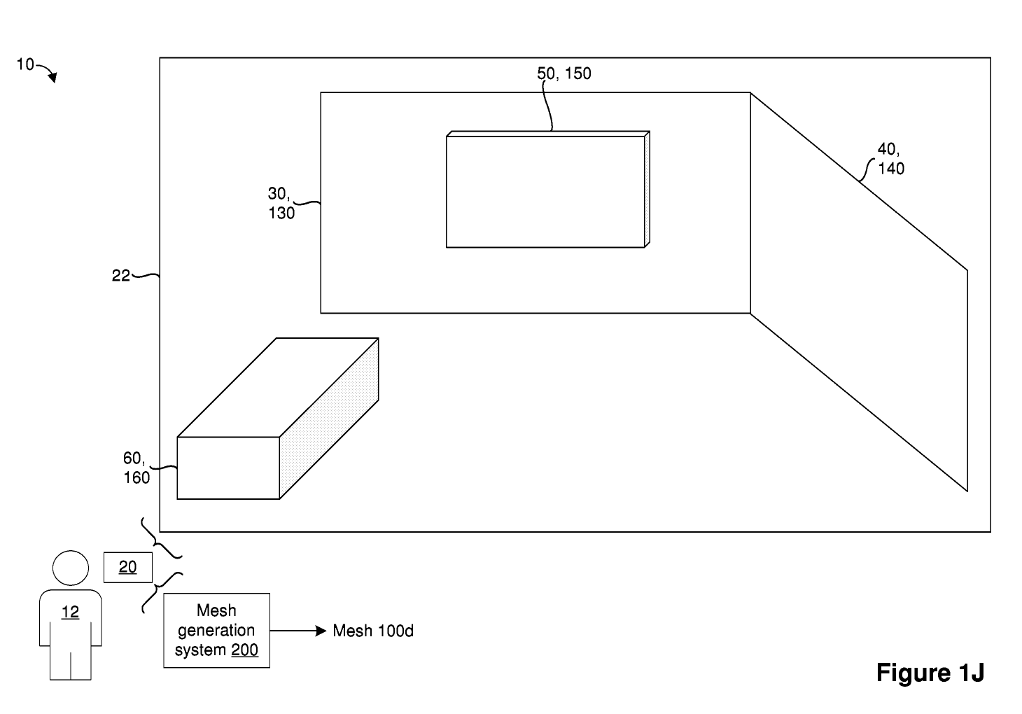

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity) and a mesh generation system 200 (“system 200”, hereinafter for the sake of brevity) for generating a mesh that is aligned with the physical environment 10. In some implementations, the system 200 resides at the device 20. Alternatively, in some implementations, the system 200 resides at another device that is in electronic communication with the device 20. For example, the device 20 includes a head-mountable device (HMD) and the system 200 resides at a smartphone that is wirelessly connected with the HMD.

In the example of FIG. 1A, the physical environment 10 includes a first physical wall 30, a second physical wall 40, a physical television (TV) 50 and a physical couch 60. In various implementations, the system 200 obtains sensor data 70 from various sensors. As illustrated in FIG. 1B, the system 200 utilizes the sensor data 70 to generate a mesh 100 for the physical environment 10. In some implementations, the sensor data 70 includes image data from an image sensor, depth data from a depth sensor, audio data from a microphone and/or Light Detection and Ranging (LIDAR) data from a LIDAR system.

Referring to FIG. 1B, the device 20 includes a display 22. In the example of FIG. 1B, the mesh 100 is overlaid onto a pass-through representation of the physical environment 10. The mesh 100 includes various mesh elements that represent corresponding physical objects from the physical environment 10. For example, the mesh 100 includes a first wall mesh 130 that represents the first physical wall 30, a second wall mesh 140 that represents the second physical wall 40, a TV mesh 150 that represents the physical TV 50 and a couch mesh 160 that represents the physical couch 60. In various implementations, the mesh 100 includes labels that identify corresponding mesh elements. For example, the mesh 100 may include a first label for the first wall mesh 130 indicating that the first wall mesh 130 corresponds to the first physical wall 30, a second label for the second wall mesh 140 indicating that the second wall mesh 140 corresponds to the second physical wall 40, a third label for the TV mesh 150 indicating that the TV mesh 150 corresponds to the physical TV 50, and a fourth label for the couch mesh 160 indicating that the couch mesh 160 corresponds to the physical couch 60.

As can be seen in FIG. 1B, the mesh 100 is misaligned with the physical environment 10. For example, the first wall mesh 130 is smaller than the first physical wall 30, the second wall mesh 140 is rotated with respect to the second wall 40, the TV mesh 150 is larger than the physical TV 50, and the couch mesh 160 is offset from the physical couch 60. The misalignment between the mesh elements and their corresponding physical objects can result in erroneous downstream operations that utilize the mesh 100. For example, if the device 20 is using the mesh 100 to overlay virtual objects onto the pass-through representation of the physical environment 10, the placement of the virtual objects may not align with positions of the physical objects. As an example, if the device 20 is placing a virtual character in a seated position on the couch mesh 160, the virtual character may appear to be sitting on empty space instead of the physical couch 60 due to the offset between the couch mesh 160 and the physical couch 60.

Referring to FIG. 1C, the system 200 determines that the couch mesh 160 is misaligned with the physical couch 60. As can be seen in FIG. 1C, a first couch corner 60a is offset from a first couch mesh corner 160a. Similarly, a second couch corner 60b is offset from a second couch mesh corner 160b. In some implementations, the system 200 determines that the couch mesh 160 is not aligned with the physical couch 60 by detecting that the first couch mesh corner 160a is not collocated with the first couch corner 60a and the second couch mesh corner 160b is not collocated with the second couch corner 60b. In order to align the couch mesh 160 with the physical couch 60, the system 200 performs a translation operation on the couch mesh 160 by moving the couch mesh 160 in a direction indicated by arrows 170. Moving the couch mesh 160 in the direction indicated by the arrows 170 results in a first modified mesh 100a shown in FIG. 1D. As can be seen in FIG. 1D, the couch mesh 160 is aligned with the physical couch 60. In the example of FIG. 1D, the first couch corner 60a and the first couch mesh corner 160a are collocated, and the second couch corner 60b and the second couch mesh corner 160b are collocated.

Referring to FIG. 1E, the system 200 compresses (e.g., downsizes) the TV mesh 150 in a direction of arrows 172 in order to resize the TV mesh 150 so that a size of the TV mesh 150 matches a size of the physical TV 50. As shown in FIG. 1F, resizing the TV mesh 150 results in a second modified mesh 100b where the TV mesh 150 has a size that is equal to the size of the physical TV 50 and the TV mesh 150 coincides with the physical TV 50.

Referring to FIG. 1G, the system 200 stretches (e.g., expands) the first wall mesh 130 in a direction of arrows 174 in order to resize the first wall mesh 130 so that a size of the first wall mesh 130 matches a size of the first physical wall 30. As shown in FIG. 1H, resizing the first wall mesh 130 results in a third modified mesh 100c where the first wall mesh 130 has a size that is equal to the size of the first physical wall 30 and the first wall mesh 130 coincides with the first physical wall 30.

Referring to FIG. 1I, the system 200 rotates the second wall mesh 140 in a clockwise direction indicated by arrows 176 in order to rotationally align the second wall mesh 140 so that an orientation of the second wall mesh 140 matches an orientation of the second physical wall 40. As shown in FIG. 1J, rotating the second wall mesh 140 results in a fourth modified mesh 100d where the second wall mesh 140 has an orientation that is the same as the orientation of the second physical wall 40 and the second wall mesh 140 coincides with the second physical wall 40.

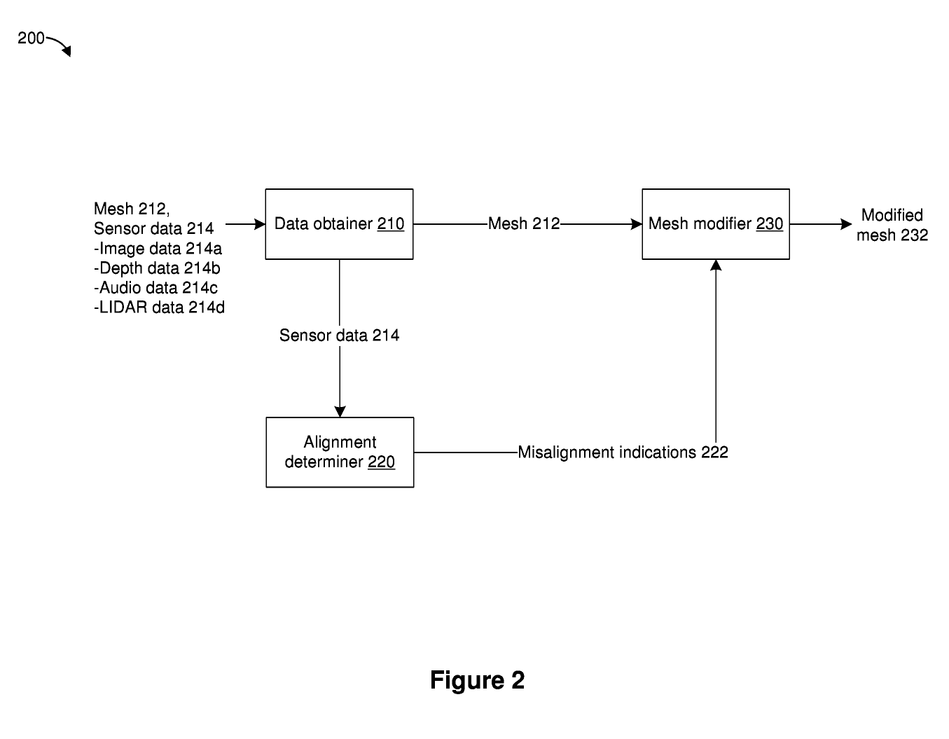

FIG. 2 is a block diagram of the system 200 in accordance with some implementations. In some implementations, the system 200 includes a data obtainer 210, an alignment determiner 220 and a mesh modifier 230. In various implementations, the data obtainer 210 obtains a mesh 212 for a physical environment. For example, the data obtainer 210 receives the mesh 100 shown in FIG. 1B. In some implementations, the data obtainer 210 generates the mesh 212 based on sensor data 214 captured by a set of one or more sensors. In some implementations, the sensor data 214 includes image data 214a captured by an image sensor. In some implementations, the image data 214a includes previously-captured images that are stored in a photos library. Additionally or alternatively, the sensor data 214 includes depth data 214b captured by a depth sensor. Additionally or alternatively, the sensor data 214 includes audio data 214c, captured by a microphone, that encodes sound reflections off surfaces in the physical environment. Additionally or alternatively, the sensor data 214 includes light detection and ranging (LIDAR) data 214d captured by a LIDAR system. The data obtainer 210 provides the sensor data 214 to the alignment determiner 220. The data obtainer 210 provides the mesh 212 to the mesh modifier 230.

In various implementations, the alignment determiner 220 determines whether or not the mesh 212 is aligned with the physical environment that the mesh 212 represents. In some implementations, the alignment determiner 220 utilizes the sensor data 214 to identify key features within the physical environment. For example, the alignment determiner 220 performs image analysis on the image data 214a to identify corners and relatively fixed objects such as wall-mounted televisions, kitchen islands, etc. In some implementations, the alignment determiner 220 determines whether mesh elements corresponding to the key features within the physical environment are collocated. For example, referring to FIG. 1C, the alignment determiner 220 determines whether the first couch mesh corner 160a is collocated with the first couch corner 60a. In some implementations, the alignment determiner 220 provides misalignment indications 222 to the mesh modifier 230. The misalignment indications 222 indicate misalignments (e.g., positional differences) between mesh elements and their corresponding physical objects. For example, referring to FIG. 1B, the misalignment indications 222 include an indication of the first wall mesh 130 being smaller than the first physical wall 30, the second wall mesh 140 being rotated with respect to the second physical wall 40, the TV mesh 150 being greater than the physical TV 50 and the couch mesh 160 being offset from the physical couch 60. In some implementations, the alignment determiner 220 performs a point-by-point comparison between positions (e.g., locations and/or orientations) of mesh elements and their corresponding physical object portions. For example, the alignment determiner 220 compares an arm rest mesh element from the couch mesh 160 with a corresponding arm rest portion of the physical couch 60 to determine whether there is a one-to-one mapping between the arm resh mesh element and the arm rest portion of the physical couch 60. In some implementations, the alignment determiner 220 detects a misalignment when a difference between respective positions (e.g., locations and/or orientations) of a mesh element and its corresponding physical object is greater than a threshold.

In various implementations, the mesh modifier 230 modifies the mesh 212 based on the misalignment indications 222 in order to generate a modified mesh 232 that is aligned with the physical environment. In some implementations, the mesh modifier 230 adjusts the mesh 212 in order to correct the misalignments indicated by the misalignment indications 222. In some implementations, the mesh modifier 230 performs a translation operation on a mesh element that is offset from a corresponding physical object in order to reduce the offset. For example, referring to FIGS. 1C and 1D, the mesh modifier 230 moves the couch mesh 160 in the direction of the arrows 170 in order to reduce the offset between the couch mesh 160 and the physical couch 60. In the example of FIG. 1D, an entirety of the couch mesh 160 is moved. However, in some implementations, a portion of the couch mesh 160 may be moved while another portion of the couch mesh 160 can be held stationary. In some implementations, the modified mesh 232 is aligned with the physical environment when a number of misalignments (e.g., a number of positional differences) between mesh elements and their corresponding physical objects is less than an alignment threshold. As an example, the couch mesh 160 is aligned with the physical couch 60 when edges of the couch mesh 160 coincide with corresponding physical edges of the physical couch 60. In some implementations, the mesh modifier 230 generates the modified mesh 232 in an iterative manner until the number of misalignments is less than the alignment threshold. In some implementations, the alignment threshold is specified by an application that utilizes the modified mesh 232.

In some implementations, the mesh modifier 230 performs a scaling operation (e.g., a compression operation or an expansion operation) on a mesh element in order to adjust a size of the mesh element so that the size of the mesh element matches a size of a corresponding physical object. For example, referring to FIGS. 1E and 1F, the mesh modifier 230 performs a compression operation on the TV mesh 150 so that the TV mesh 150 matches the physical TV 50 in size. As another example, referring to FIGS. 1G and 1H, the mesh modifier 230 performs an expansion operation (e.g., a stretching operation) on the first wall mesh 130 so that the first wall mesh 130 matches the first physical wall 30 in size.

In some implementations, the mesh modifier 230 performs a rotational operation on a mesh element in order to adjust an orientation of the mesh element so that the orientation of the mesh element matches an orientation of a corresponding physical object. For example, referring to FIGS. 1I and 1J, the mesh modifier 230 performs a rotational operation on the second wall mesh 140 so that an orientation of the second wall mesh 140 matches an orientation of the second physical wall 40.

In some implementations, the mesh modifier 230 determines that modifying a portion of the mesh 212 triggers a subsequent modification to another portion of the mesh 212. For example, the mesh modifier 230 determines that compressing or moving a portion of the mesh 212 results in a hole. In such implementations, the mesh modifier 230 performs a hole filling operation in order to fill the hole that was created by modifying the mesh 212. Examples of the hole filling operations include performing a triangulation operation that connects boundary edges to fill relatively small holes, performing a surface reconstruction by utilizing a smoothing function and performing a blending operation (e.g., by using Laplacian smoothing or Taubin smoothing).

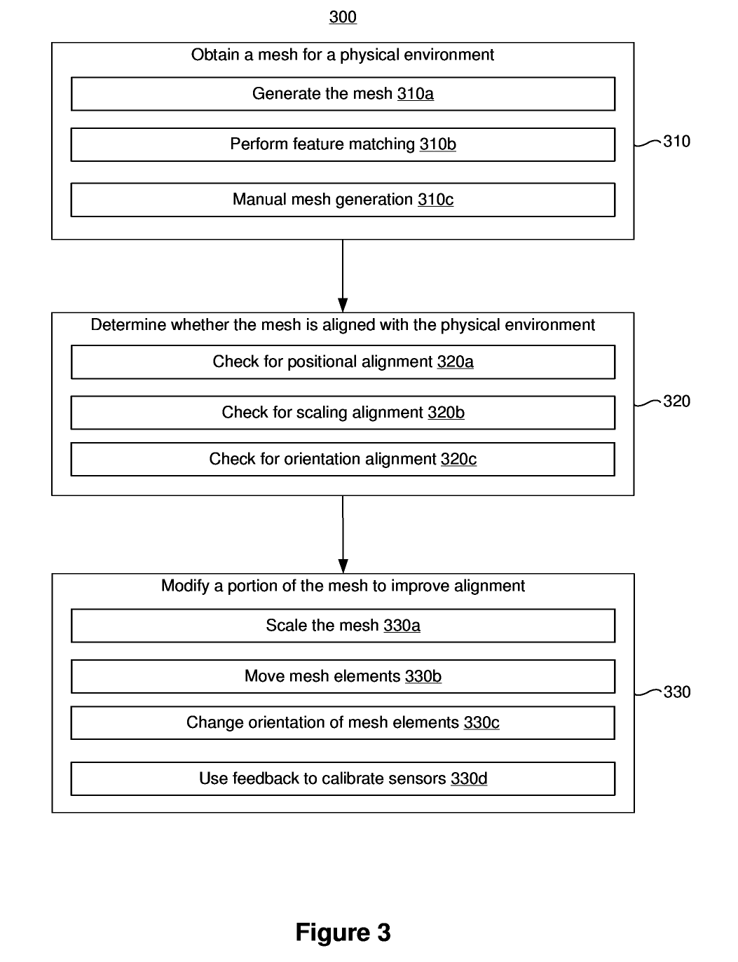

FIG. 3 is a flowchart representation of a method 300 for aligning a mesh with a physical environment. In various implementations, the method 300 is performed by a device including a display, a non-transitory memory and one or more processors coupled with the display and the non-transitory memory (e.g., the device 20 shown in FIGS. 1A-1J and/or the system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in some implementations, the method 300 includes obtaining a mesh for a physical environment. For example, as shown in FIG. 2, the data obtainer 210 obtains the mesh 212. In some implementations, the mesh includes a plurality of mesh elements that correspond to respective physical points in the physical environment. For example, as shown in FIG. 1B, each mesh element corresponds to (e.g., represents) a particular physical object.

As represented by block 310a, in some implementations, the method 300 includes obtaining sensor data and generating the mesh based on the sensor data. For example, as shown in FIGS. 1A and 1B, the system 200 obtains the sensor data 70 and generates the mesh 100 based on the sensor data 70. In some implementations, obtaining the sensor data includes receiving the sensor data from a LIDAR. For example, as shown in FIG. 2, the sensor data 214 includes LIDAR data 214d. In some implementations, obtaining the sensor data includes receiving image data captured by an image sensor (e.g., the image data 214a shown in FIG. 2). In some implementations, obtaining the sensor data includes receiving depth data captured by a depth sensor (e.g., the depth data 214b shown in FIG. 2). In some implementations, obtaining the sensor data includes receiving audio data captured by a microphone (e.g., the audio data 214c shown in FIG. 2).

As represented by block 310b, in some implementations, obtaining the mesh includes obtaining image data from a stereoscopic imaging system and performing stereoscopic feature matching on the image data to generate the mesh. For example, referring to FIG. 2, the data obtainer 210 receives the image data 214a from a stereoscopic camera system and the data obtainer 210 generates the mesh 212 by performing stereoscopic feature matching on the image data 214a.

As represented by block 310c, in some implementations, obtaining the mesh includes obtaining a series of user inputs that correspond to manually generating the mesh. For example, referring to FIGS. 1A and 1B, in some implementations, the device 20 presents a graphical user interface (GUI) that allows the user 12 to manually create the mesh 100. In some implementations, the user 12 manually creates the mesh 100 and the system 200 refines the mesh 100 by correcting misalignments between the mesh 100 and the physical environment 10 thereby assisting the user 12 in creating a mesh that more accurately represents the physical environment 10.

As represented by block 320, in some implementations, the method 300 includes determining whether the mesh is aligned with the physical environment based on a comparison between the plurality of mesh elements and the respective physical points in the physical environment. For example, as described in relation to FIG. 2, the alignment determiner 220 determines whether the mesh 212 is aligned with a physical environment that the mesh 212 represents. In some implementations, the method 300 includes identifying key features within the physical environment and determining whether the mesh includes mesh elements that correspond to the key features within the physical environment. For example, the device determines whether virtual locations of the mesh elements within the mesh match physical locations of the key features that the mesh elements represent. In some implementations, the method 300 includes determining that the misalignment between the mesh and the physical environment is not due to changes in the physical environment. For example, the device monitors changes in depth data provided by an IMU over a period of time. In this example, the device determines that the physical environment has not changed when changes in the depth data are less than a threshold amount of change (e.g., when the depth data does not change over the period of time).

As represented by block 320a, in some implementations, determining whether the mesh is aligned with the physical environment includes selecting, from the plurality of mesh elements, a first mesh element that corresponds to a first physical point from the respective physical points, and determining whether virtual spatial coordinates of the first mesh element match (e.g., coincide with) real-world spatial coordinates of the first physical point when the mesh is overlaid onto the physical environment. In some implementations, the virtual spatial coordinates of the first mesh element match the real-world spatial coordinates of the first physical point when the first mesh element and the first physical point overlap with each other while the mesh is overlaid onto a pass-through representation of the physical environment. For example, when the first mesh element and the first physical point have the same coordinates.

In some implementations, the first physical point represents a physical furniture item in the physical environment and the first mesh element represents a virtual furniture item, and determining whether the mesh is aligned includes determining whether the virtual furniture item overlaps with the physical furniture item. For example, referring to FIGS. 1B and 2, the alignment determiner 220 determines whether virtual spatial coordinates of the couch mesh 160 coincide with real-world spatial coordinates of the physical couch 60 that the couch mesh 160 represents.

In some implementations, the first physical point is a physical corner and the first mesh element is a virtual corner, and determining whether the mesh is aligned includes determining whether the virtual corner in the mesh coincides with the physical corner. For example, referring to FIGS. 1C and 2, the alignment determiner 220 determines whether the first couch corner 60a is collocated with the first couch mesh corner 160a and whether the second couch corner 60b is collocated with the second couch mesh corner 160b.

In some implementations, the first physical point represents a physical architectural element and the first mesh element represents a virtual architectural element, and determining whether the mesh is aligned includes determining whether the virtual architectural element overlaps with the physical architectural element. For example, in some implementations, the first physical point represents a kitchen island and determining whether the mesh aligns with the physical environment includes determining whether a mesh element that represents the kitchen island has the same coordinates as the kitchen island when the mesh is overlaid onto a pass-through representation of the physical environment. As another example, the first physical point represents a built-in shelf and determining whether the mesh aligns with the physical environment includes determining whether a mesh element that represents the built-in shelf has the same coordinates as the built-in shelf when the mesh is overlaid onto a pass-through representation of the physical environment.

As represented by block 320b, in some implementations, determining whether the mesh is aligned with the physical environment includes selecting, from the plurality of mesh elements, two mesh elements, and determining whether a virtual distance between the two mesh elements matches a physical distance between two of the physical points that correspond to the two mesh elements. As an example, the device determines whether a virtual distance between two virtual walls matches a physical distance between two corresponding physical walls. As an example, referring to FIGS. 1B and 2, the alignment determiner 220 determines whether a distance from a center of the couch mesh 160 to the second wall mesh 140 matches a distance from a center of the physical couch 60 to the second physical wall 40. In this example, since the couch mesh 160 is offset from the physical couch 60, the distances are not same and the alignment determiner 220 determines that the mesh 100 is misaligned with the physical environment 10.

As represented by block 320c, in some implementations, determining whether the mesh is aligned with the physical environment includes selecting, from the plurality of mesh elements, a particular mesh element with a first orientation, and determining whether a subset of the physical points that corresponds to the particular mesh element has the first orientation. As an example, the device selects a virtual painting (e.g., a mesh element representing a physical painting) that has a first orientation and determines whether the corresponding physical painting has the first orientation. As another example, referring to FIGS. 1B and 2, the alignment determiner 220 determines that the second wall mesh 140 is misaligned with the second wall 40 because the second wall mesh 140 is angularly misaligned with the second physical wall 40 (e.g., because the second wall mesh 140 and the second physical wall 40 have different orientations).

As represented by block 330, in some implementations, the method 300 includes, in response to determining that the mesh is misaligned with the physical environment, modifying a portion of the mesh in order to generate a modified mesh that is aligned with the physical environment. For example, as shown in FIG. 2, the mesh modifier 230 modifies the mesh 212 in order to generate the modified mesh 232 based on the misalignment indications 222.

As represented by block 330a, in some implementations, modifying the portion of the mesh includes scaling the portion of the mesh so that a virtual scale of the portion of the mesh matches with a physical scale of a corresponding portion of the physical environment. In some implementations, the method 300 includes compressing the portion of the mesh. For example, as shown in FIGS. 1E and 1F, the system 200 compresses the TV mesh 150 to match the physical TV 50 in size. In some implementations, the method 300 includes stretching the portion of the mesh. For example, as shown in FIGS. 1G and 1H, the system 200 expands the first wall mesh 130 in order to match the first physical wall 30 in size. As another example, if a mesh element representing a doorway is too short then the device stretches the mesh element to match a height of the doorway.

As represented by block 330b, in some implementations, modifying the portion of the mesh includes moving the portion of the mesh from a first virtual position within the mesh to a second virtual position within the mesh so that the portion of the mesh is collocated with a corresponding portion of the physical environment. For example, as shown in FIGS. 1C and 1D, the system 200 moves the couch mesh 160 so that the couch mesh corners 160a and 160b align with the couch corners 60a and 60b, respectively. As another example, the device moves a mesh corner so that the mesh corner coincides with a corresponding physical corner.

As represented by block 330c, in some implementations, modifying the portion of the mesh includes changing an orientation of the portion of the mesh from a first orientation to a second orientation so that the portion of the mesh is oriented the same as a corresponding portion of the physical environment. For example, as shown in FIGS. 1I and 1J, the system 200 rotates the second wall mesh 140 so that the second wall mesh 140 is angularly aligned with the second physical wall 40. As another example, the device rotates a rectangular mesh element that represents a physical TV so that the rectangular mesh element has the same orientation as the physical TV that the rectangular mesh element represents.

As represented by block 330d, in some implementations, the method 300 includes calibrating a sensor based on a misalignment between the mesh and the physical environment. In some implementations, the misalignment between the mesh and the physical environment is due to sensor noise in sensor data captured by a sensor. As such, calibrating the sensor based on the misalignment (e.g., based on an amount of misalignment or a degree of misalignment) tends to reduce sensor noise. Using a degree of misalignment as feedback to calibrate the sensor tends to improve the quality of subsequently-captured sensor data that is used to refine the mesh or generate a new mesh. Calibrating the sensor based on the misalignment between the mesh and the physical environment tends to result in a mesh that is better aligned with a physical environment that the mesh represents thereby reducing the need to utilize computing resources associated with aligning the mesh with the physical environment.

In various implementations, aligning the mesh with the physical environment enhances an accuracy of the mesh so that the mesh is a more accurate representation of the physical environment. Aligning the mesh with the physical environment allows the device to accurately overlay virtual objects onto representations of physical objects in the physical environment. For example, referring to FIG. 1D, placing a virtual character in a seated position on the couch mesh 160 after aligning the couch mesh 160 with the physical couch 60 provides an appearance that the virtual character is sitting on the physical couch 60 and not offset from the physical couch 60.

In some implementations, the device determines whether the physical environment has changed since the mesh was generated. If the physical environment has not changed since the mesh was generated, then misalignments between the mesh and the physical environment are likely a result of sensor noise, sensor drift, sensor miscalibration or errors in mesh generation. As such, the device modifies the mesh to better align the mesh with the physical environment. If the device determines that the physical environment has changed since the mesh was generated, the device quantifies the amount of change. If the amount of change is less than a threshold, the device can modify the mesh to account for the change in the physical environment instead of generating a new mesh. However, if the amount of change is greater than the threshold, the device forgoes modifying the mesh and generates a new mesh.

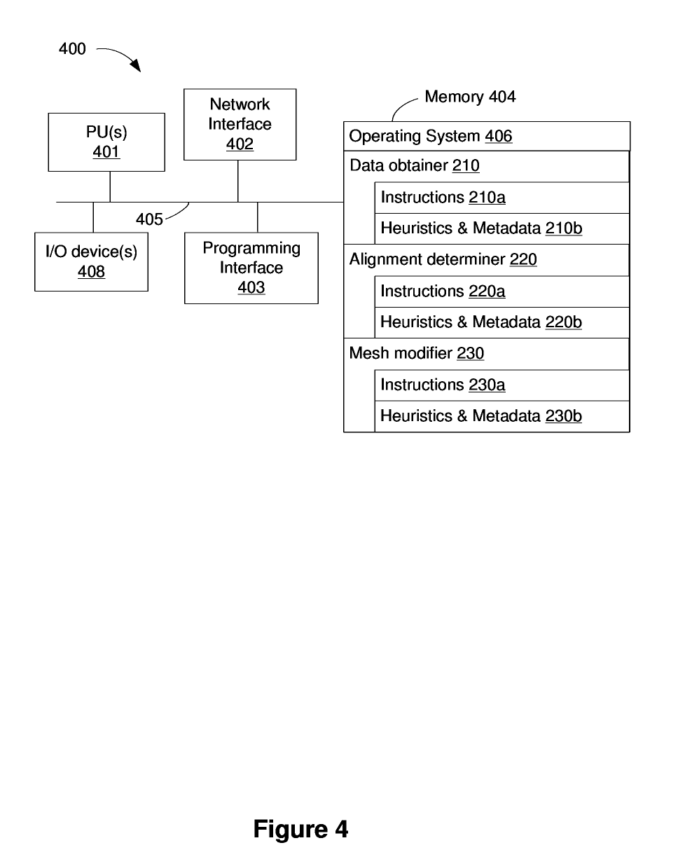

FIG. 4 is a block diagram of a device 400 in accordance with some implementations. In some implementations, the device 400 implements the device 20 shown in FIGS. 1A-1J and/or the system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the alignment determiner 220 and the mesh modifier 230. In various implementations, the device 400 performs the method 300 shown in FIG. 3.

In some implementations, the data obtainer 210 includes instructions 210a, and heuristics and metadata 210b for obtaining data (e.g., the mesh 212 and the sensor data 214 shown in FIG. 2). In some implementations, the data obtainer 210 performs at least some of the operation(s) represented by block 310 in FIG. 3.

In some implementations, the alignment determiner 220 includes instructions 220a, and heuristics and metadata 220b for determining a misalignment between the mesh and the physical environment (e.g., the misalignment indications 222 shown in FIG. 2). In some implementations, the alignment determiner 220 performs at least some of the operation(s) represented by block 320 in FIG. 3.

In some implementations, the mesh modifier 230 includes instructions 230a, and heuristics and metadata 230b for generating a modified mesh by modifying the mesh based on misalignments detected by the alignment determiner 220 (e.g., for generating the modified meshes 100a, 100b, 100c,100d and 232 shown in FIGS. 1C-2). In some implementations, the mesh modifier 230 performs at least some of the operation(s) represented by block 330 in FIG. 3.

In some implementations, the one or more I/O devices 408 include a set of one or more sensors for capturing sensor data (e.g., the sensor data 214 shown in FIG. 2). In some implementations, the sensors include a camera for capturing the image data 214a shown in FIG. 2, a depth sensor (e.g., a depth camera) for capturing the depth data 214b shown in FIG. 2, an audio sensor (e.g., a microphone) for capturing the audio data 214c shown in FIG. 2, and/or a LIDAR system for capturing the LIDAR data 214d shown in FIG. 2. In some implementations, the one or more I/O devices 408 receive user inputs (e.g., for receiving user inputs that correspond to the user 12 manually creating the mesh 100 shown in FIG. 1B).

In various implementations, the one or more I/O devices 408 include a video pass-through display which displays at least a portion of a physical environment surrounding the device 400 as an image captured by the camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a display, a non-transitory memory and one or more processors:
obtaining a mesh for a physical environment, wherein the mesh includes a plurality of mesh elements that correspond to respective physical points in the physical environment;
determining whether the mesh is aligned with the physical environment based on a comparison between the plurality of mesh elements and the respective physical points in the physical environment; and
in response to determining that the mesh is misaligned with the physical environment, modifying a portion of the mesh in order to generate a modified mesh that is aligned with the physical environment.

2. The method of claim 1, wherein determining whether the mesh is aligned with the physical environment comprises:
selecting, from the plurality of mesh elements, a first mesh element that corresponds to a first physical point from the respective physical points; and
determining whether virtual spatial coordinates of the first mesh element match real-world spatial coordinates of the first physical point when the mesh is overlaid onto the physical environment.

3. The method of claim 2, wherein the first physical point is a physical corner and the first mesh element is a virtual corner; and
wherein determining whether the mesh is aligned comprises determining whether the virtual corner in the mesh coincides with the physical corner.

4. The method of claim 2, wherein the first physical point represents a physical furniture item in the physical environment and the first mesh element represents a virtual furniture item; and
determining whether the mesh is aligned comprises determining whether the virtual furniture item overlaps with the physical furniture item.

5. The method of claim 2, wherein the first physical point represents a physical architectural element and the first mesh element represents a virtual architectural element; and
determining whether the mesh is aligned comprises determining whether the virtual architectural element overlaps with the physical architectural element.

6. The method of claim 1, wherein determining whether the mesh is aligned with the physical environment comprises:
selecting, from the plurality of mesh elements, two mesh elements; and
determining whether a virtual distance between the two mesh elements matches a physical distance between two of the physical points that correspond to the two mesh elements.

7. The method of claim 1, wherein determining whether the mesh is aligned with the physical environment comprises:
selecting, from the plurality of mesh elements, a particular mesh element with a first orientation; and
determining whether a subset of the physical points that corresponds to the particular mesh element has the first orientation.

8. The method of claim 1, wherein modifying the portion of the mesh comprises scaling the portion of the mesh so that a virtual scale of the portion of the mesh matches with a physical scale of a corresponding portion of the physical environment.

9. The method of claim 1, wherein modifying the portion of the mesh comprises moving the portion of the mesh from a first virtual position within the mesh to a second virtual position within the mesh so that the portion of the mesh is collocated with a corresponding portion of the physical environment.

10. The method of claim 1, wherein modifying the portion of the mesh comprises changing an orientation of the portion of the mesh from a first orientation to a second orientation so that the portion of the mesh is oriented same as a corresponding portion of the physical environment.

11. The method of claim 1, further comprising:
calibrating a sensor based on detected misalignment between the mesh and the physical environment.

12. The method of claim 1, further comprising obtaining sensor data and generating the mesh based on the sensor data.

13. The method of claim 12, wherein obtaining the sensor data comprises receiving the sensor data from a LIDAR.

14. The method of claim 1, wherein obtaining the mesh comprises obtaining image data from a stereoscopic imaging system and performing stereoscopic feature matching on the image data to generate the mesh.

15. The method of claim 1, wherein obtaining the mesh comprises obtaining a series of user inputs that correspond to manually generating the mesh.

16. A device comprising:
a display;
one or more processors;
a non-transitory memory; and
one or more programs stored in the non-transitory memory, which, when executed by the one or more processors, cause the device to:
obtain a mesh for a physical environment, wherein the mesh includes a plurality of mesh elements that correspond to respective physical points in the physical environment;
determine whether the mesh is aligned with the physical environment based on a comparison between the plurality of mesh elements and the respective physical points in the physical environment; and
in response to determining that the mesh is misaligned with the physical environment, modify a portion of the mesh in order to generate a modified mesh that is aligned with the physical environment.

17. The device of claim 16, wherein the one or more programs cause the device to modify the portion of the mesh by scaling the portion of the mesh so that a virtual scale of the portion of the mesh matches with a physical scale of a corresponding portion of the physical environment.

18. The device of claim 16, wherein the one or more programs cause the device to modify the portion of the mesh by moving the portion of the mesh from a first virtual position within the mesh to a second virtual position within the mesh so that the portion of the mesh is collocated with a corresponding portion of the physical environment.

19. The device of claim 16, wherein the one or more programs cause the device to modify the portion of the mesh by changing an orientation of the portion of the mesh from a first orientation to a second orientation so that the portion of the mesh is oriented same as a corresponding portion of the physical environment.

20. A non-transitory memory storing one or more programs, which, when executed by one or more processors of a device coupled with a display cause the device to:
obtain a mesh for a physical environment, wherein the mesh includes a plurality of mesh elements that correspond to respective physical points in the physical environment;
determine whether the mesh is aligned with the physical environment based on a comparison between the plurality of mesh elements and the respective physical points in the physical environment; and
in response to determining that the mesh is misaligned with the physical environment, modify a portion of the mesh in order to generate a modified mesh that is aligned with the physical environment.
